(19) United States
(12) Patent Application Publication
(10) Pub. No.: US 2001/0054171 A1
(43) Pub. Date: Dec. 20, 2001

(54) Method of designing a semiconductor circuit and a semiconductor circuit designed using the method

(76) Inventors: Mitsuaki Furumoto, Tokyo (JP); Hiroomi Nakao, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/729,088

(22) Filed: Dec. 5, 2000

(30) Foreign Application Priority Data
Jun. 20, 2000 (JP) 2000-184817

(51) Int. Cl. G06F 17/50

(52) U.S. Cl. 716/6; 716/1; 716/2

(57) ABSTRACT

In the method of designing a semiconductor circuit having clock trees, a netlist is first generated. Then, a delay gates are inserted onto said netlist. Finally, inserted extra delay gates are deleted based on a timing constraint the clock trees is satisfied or not. As a consequence, skew between the clock trees can be easily adjusted.

### FIELD OF THE INVENTION

The present invention relates to a method of designing a semiconductor circuit and a semiconductor circuit designed using this method. More particularly, this invention relates to a method of designing a semiconductor circuit in which clock lines are designed in a clock tree and a semiconductor circuit designed using this method.

### BACKGROUND OF THE INVENTION

FIG. 9 is a flowchart showing a sequence of processing in a conventional method of designing a semiconductor circuit. This method is disclosed in Japanese Unexamined Patent Application No. 10-229130. A library for storing route data of clock lines in a clock tree shape in which line length is uniform is prepared beforehand. In step 101, a circuit is input. In step S102, clock lines are wired in a clock tree shape. In step S103 of test place for overlapping the final stage of the clock tree.

The method also comprises the step S104 of eliminating an unused clock line so as not to change the original load of the clock lines and step S105 for newly determining route and place.

In recent years, the chips are becoming smaller and smaller in size and their processing speed is increasing day by day. As a consequence, a clock line skew is getting hard to be adjusted. The conventional method of adjusting a skew in clock lines has a disadvantage that a dedicated place library for clock lines or a dedicated CAD tool is necessary.

### SUMMARY OF THE INVENTION

According to the method of designing a semiconductor circuit of this invention, there are provided the steps of generating a netlist; inserting a plurality of delay gates onto the netlist; place; generating the clock trees which satisfy a constraint of a timing in the clock tree; route; manually adjusting a skew between the clock trees by deleting some of the inserted delay gates based on the constraint of the timing between the clock trees; examining the skew between the clock trees; determining whether the constraint of the timing is satisfied or not; and making a minimum change in the place and route in association with the insertion of the delay gates.

According to still another aspect of this invention, a semiconductor circuit is designed using the above method.

Other objects and features of this invention will become apparent from the following description with reference to the accompanying drawings.

### BRIEF DESCRIPTION OF THE DRAWINGS

FIG. 1 is a flowchart showing a sequence of processing in a method of designing a semiconductor circuit according to a first embodiment of the invention.

FIG. 2 is a circuit diagram of clock trees according to the first embodiment of the invention.

FIG. 3 is a flowchart showing a sequence of processing in a method of designing a semiconductor circuit according to a second embodiment of the invention.

FIG. 4 is a circuit diagram of clock trees according to the second embodiment of the invention.

FIG. 5 is a flowchart showing a sequence of processing in a method of designing a semiconductor circuit according to a third embodiment of the invention.

FIG. 6 is a circuit diagram of clock trees according to the third embodiment of the invention.

FIG. 7 is a flowchart showing a sequence of processing in a method of designing a semiconductor circuit according to a fourth embodiment of the invention.

FIG. 8 is a flowchart showing a sequence of processing in a method of designing a semiconductor circuit according to a fifth embodiment of the invention.

FIG. 9 is a flowchart showing a sequence of processing in a conventional method of designing a semiconductor circuit.

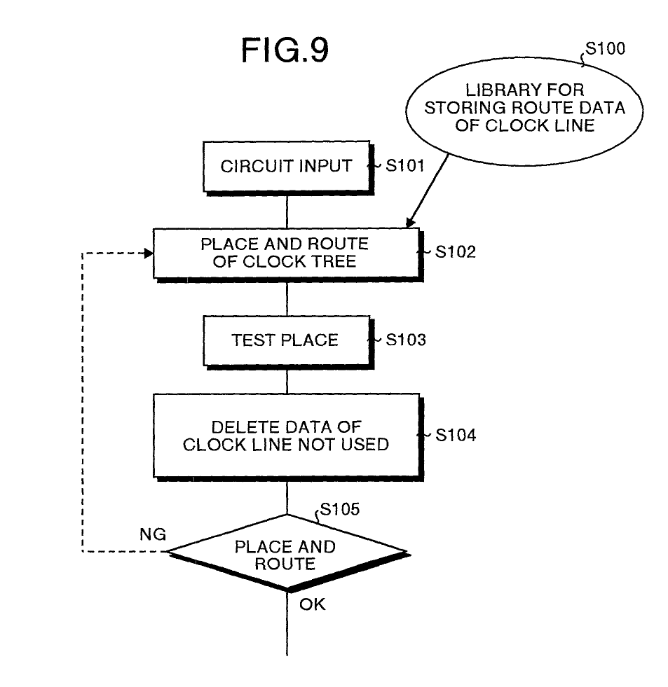

### DESCRIPTION OF THE PREFERRED EMBODIMENTS

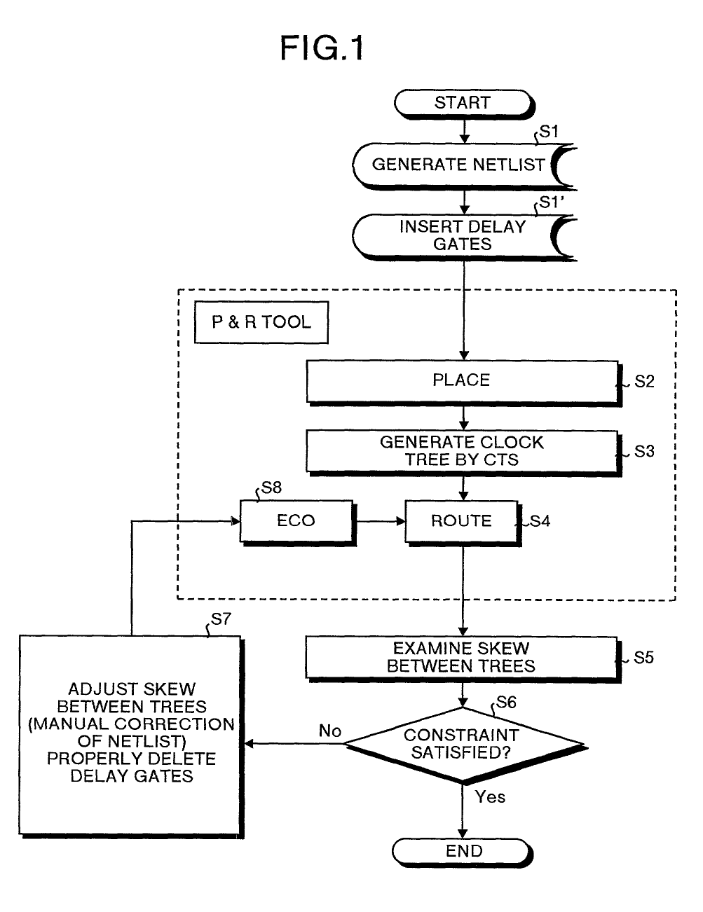

Preferred embodiments of the present invention will be described herein below with reference to drawings. FIG. 1 is a flowchart showing a sequence of processing in a method of designing a semiconductor circuit according to a first embodiment. The method comprises the step S1 of generating a netlist, step S1′ of inserting a delay gate, and steps related to operations of a Place and Route tool (hereafter will be referred to as a P & R tool) for automatically generating a clock tree while satisfying constrains of a timing in the clock tree.

The P & R tool performs operations in the following sequence. That is the step S2 of place; step S3 of generating a clock tree by a Clock Tree Synthesis (hereafter will be referred to as a CTS) function; step S8 of an Engineering Change Order (hereafter will be referred to as an ECO) function for making a minimum change in the place in association with insertion of a delay gate; and step S4 of route.

The method further comprises the step S7 for manually adjusting a skew between clock trees (hereafter described as adjustment of a skew between trees); step S5 for examining a skew between the clock trees; and step S6 for determining whether the constrain of a timing can be satisfied or not.

A netlist is generated (state where the logic examination has also been completed) in step S1. After that, delay gates are preliminarily inserted in step S1′.

The P & R tool performs place in step S2, generates a clock tree which satisfies the constrain of the timing in the clock tree by the CTS function in step S3, and carries out routing in step S4.

Next, in step S5, in order to know whether the constrain of the timing between the clock trees is satisfied or not, a delay value of a clock line is calculated by a timing examining tool with an actual delay value extracted from the place, and time (nano seconds, hereafter referred to as “ns”) of the timing skew between the clock trees is checked. Since the constrain of the timing in the clock tree is satisfied by the P & R tool, it is unnecessary to examine the timing skew.

After the skew between the clock trees is examined in step S5, whether the constrain of the timing between the clock trees is satisfied or not is determined in step S6. If the result of this determination is no, the skew between the trees is adjusted in step S7. If the result of this determination is yes, then the process in this flowchart is finished.

In step S1′, a plurality of delay gates are preliminarily inserted in clock lines on the netlist. The proper number of the plurality of delay gates preliminarily inserted are eliminated in the adjustment of the skew between the trees in step S7. An adjustment of a skew between trees by eliminating the proper number of delay gates from the plurality of delay gates preliminarily inserted is easier than an adjustment by inserting delay gates for the following reason.

When a change in wire length in the case of inserting a delay gate is compared with a change in wire length in the case of eliminating a delay gate, the probability of occurrence of a place change or route change (especially, bypass route which occurs due to a reduction in the route area in association with insertion of a delay gate) in the case where a delay gate is eliminated is lower than that in the case where a delay gate is inserted.

Since a skew between the trees is examined in step S5 before the skew between the trees is adjusted in step S7 (before delay gates are inserted or eliminated), in the adjustment of the skew in trees in step S7, each of delay gates on a clock line and a route delay related to the delay gate are known. Consequently, a change in the delay value for each of gates when the gate is eliminated can be roughly grasped.

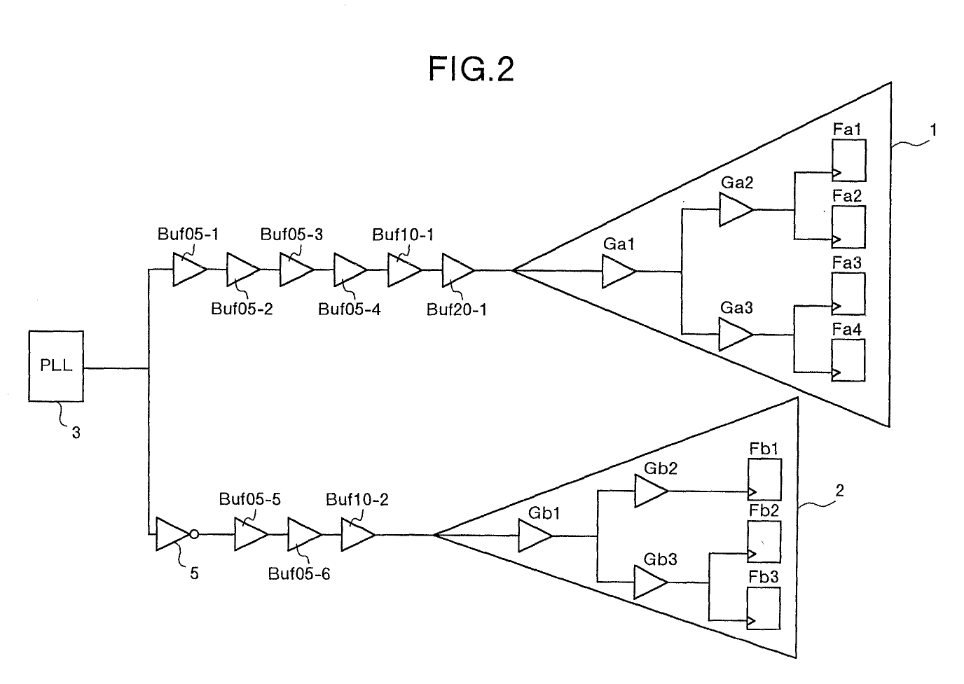

FIG. 2 is a circuit diagram of clock trees according to the first embodiment. This circuit comprises a PLL 3 for outputting a clock A; an inverter circuit 5 for outputting a clock B obtained by inverting the clock A; a clock tree 1 driven by the clock A; and a clock tree 2 driven by the inverted clock B.

The clock tree 1 comprises a plurality of flip-flops Fa1 to Fa4 and a plurality of delay gates Ga1 to Ga3. The clock tree 2 comprises a plurality of flip-flops Fb1 to Fb3 and a plurality of delay gates Gb1 to Gb3.

In step S1′ in the flowchart of FIG. 1, a plurality of delay gates Buf05-1, Buf05-2, Buf05-3, Buf05-4, Buf10-1, and Buf20-1 for delaying the clock tree 1 and a plurality of delay gates Buf05-5, Buf05-6, and Buf10-2 for delaying the clock tree 2 are inserted.

The operation of the circuit will be described in accordance with the flowchart of FIG. 1. First, constrains of timings in the clock trees 1 and 2 “to suppress a clock skew in the clock tree 1 to 0.5 ns or less (by using the output pin of the delay gate Ga1 as a starting point)” and “to suppress a clock skew in the clock tree 2 to 0.5 ns or less (by using the output pin of the delay gate Gb1 as a starting point)” are placed.

A constrain of timings between the clock trees “to delay an average value of delay values from the starting point to each of the flip-flops in the clock tree 1 from an average value of delay values from the starting point to each of the flip-flops in the clock tree 2 by 2 nm (when the starting point is the output pin of the PLL)” is placed.

After forming the netlist in step S1, the delay gates are preliminarily inserted in step S1′. By inserting delay gates each having a small delay value, a fine adjustment of a skew between the trees in step S7 can be realized. After step S1′, place, generation of clock trees and route are carried out in steps S2 to S4, and a skew between the trees is examined in step S5.

It is now assumed that, as a result of the examination in step S5, an average value Aave of delay values from the starting point (the output pin of the PLL) to the flip-flops in the clock tree 1 is 6.40 ns and an average value Bave of delay values from the starting point (the output pin of the PLL) to the flip-flops in the clock tree 2 is 3.40 ns.

In order to satisfy the given constraint of Aave=Bave+2 ns, it is necessary to eliminate a delay of 1.00 ns from the clock tree 1. For example, the delay gate Buf10-1 is eliminated instep S7. It is almost unnecessary to consider a change in route or place in association with the elimination.

After that, an ECO is performed in step SB, route is conducted in step S4, a skew between the clock trees is examined in step S5, and it is confirmed that the constraint is satisfied in step S6.

According to the first embodiment, as compared with the conventional method of designing a semiconductor circuit, since the constraint can be satisfied only by eliminating a delay gate, time required to adjust a skew between trees can be shortened.

The method can be realized by an existing apparatus without requiring a dedicated place library for clock lines or a dedicated CAD tool.

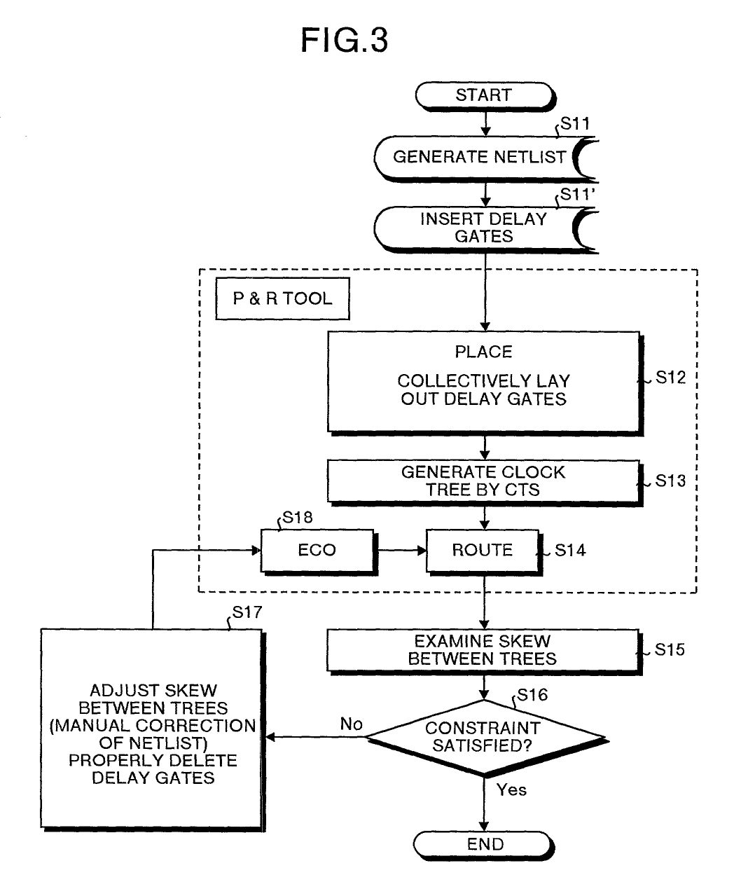

FIG. 3 is a flowchart showing a sequence of processing in a method of designing a semiconductor circuit according to the second embodiment. The method comprises the step S11 of generating a netlist, step S11′ of inserting delay gates and steps performed by the P & R tool.

The P & R tool performs place in step S12 of placing a plurality of delay gates on a clock line, step S13 of forming a clock tree by the CTS function, step S18 of performing an operation by using the ECO function, and route step S14.

The method further comprises the step S17 of adjusting a skew between trees, step S15 of examining the skew between the clock trees, and step S16 of determining whether the constraints are satisfied or not.

After generating the netlist in step S11 (in a state where the logic examination has been also finished), a delay gate is inserted in advance in step S11′.

The P & R tool places delay gates collectively to each of the clock lines in step S12, generates a clock tree which satisfies the constraint of the timing in the clock tree by the CTS function in step S13 and, after that, conducts route in step S14.

In order to know whether the constraint of the timing between the clock trees is satisfied or not in step S15, a delay value of the clock line is calculated by a timing examining tool by using an actual delay value extracted from the place, and a timing skew between the clock trees is examined. Since the constraint of the timing in the clock tree is satisfied by the P & R tool, it is unnecessary to perform the examination.

As a result of examining a skew between the clock trees in step S15, whether the constraint of the timing between the clock trees is satisfied or not is determined in step S16. If the result of this determination is no, then the skew between the trees is adjusted in step S17. If the result of this determination is yes, then the process in this flowchart is finished.

In step S11′, a plurality of delay gates are preliminarily inserted in the clock line on the netlist. The delay gates are properly eliminated from the plurality of delay gates preliminarily inserted to adjust the skew between the trees in step S17. The adjustment of properly eliminating the delay gates from the plurality of delay gates preliminarily inserted is easier than the adjustment of inserting a delay gate for the following reason.

Because, when a change in wire length in the case of inserting a delay gate is compared with a change in wire length in the case of eliminating a delay gate, the probability of occurrence of a place change or route change (especially, bypass route which occurs due to a reduction in the route area in association with insertion of a delay gate) in the case where a delay gate is eliminated is lower than that in the case where a delay gate is inserted.

Since a skew between the trees is examined in step S15 before the skew between the trees is adjusted in step S17 (before a delay gate is inserted or eliminated), in the adjustment of the skew between trees in step S17, each of delay gates on the clock line and a route delay related to the delay gate are known. Consequently, a change in the delay value which occurs when a gate is eliminated can be roughly grasped.

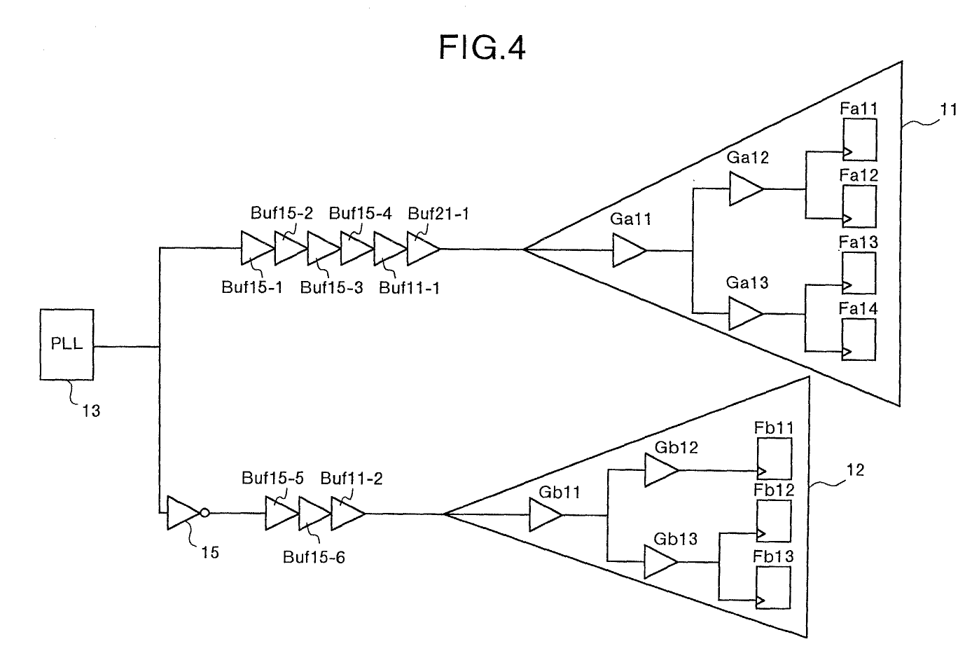

FIG. 4 is a circuit diagram of clock trees according to the second embodiment. This circuit comprises a PLL 13 for outputting a clock A; an inverter circuit 15 for outputting a clock B obtained by inverting the clock A; a clock tree 11 driven by the clock A; and a clock tree 12 driven by the inverted clock B.

The clock tree 11 comprises a plurality of flip-flops Fa11 to Fa14 and a plurality of delay gates Ga11 to Ga13. The clock tree 12 comprises a plurality of flip-flops Fb11 to Fb13 and a plurality of delay gates Gb11 to Gb13.

In appliance of the step S11′ in the flowchart of FIG. 3, a plurality of delay gates Buf15-1, Buf15-2, Buf15-3, Buf15-4, Buf11-1, and Buf21-1 for delaying the clock tree 11 and a plurality of delay gates Buf15-5, Buf15-6, and Buf11-2 for delaying the clock tree 12 are inserted.

If the delay gates Buf11-1 and Buf21-1 are disposed far away from each other then the derivability of the delay gate Buf15-4 is lower than that of the delay gate Buf11-1, if the delay date Buf11-1 is eliminated as a result of the adjustment of the skew between the trees, a load on the delay gate Buf15-4 at the front stage of the delay gate Buf11-1 increases.

On the other hand, when delay gates to be inserted on the same clock line are disposed collectively, even after eliminating a certain delay gate, a load on the delay gate at the front stage does not increase so much. Consequently, the delay value of the whole delay gates does not increase so much and the adjustment of a skew between trees is easy.

According to the second embodiment, the time required to adjust a skew between trees can be further shortened as compared with the method of adjusting a skew in the first embodiment.

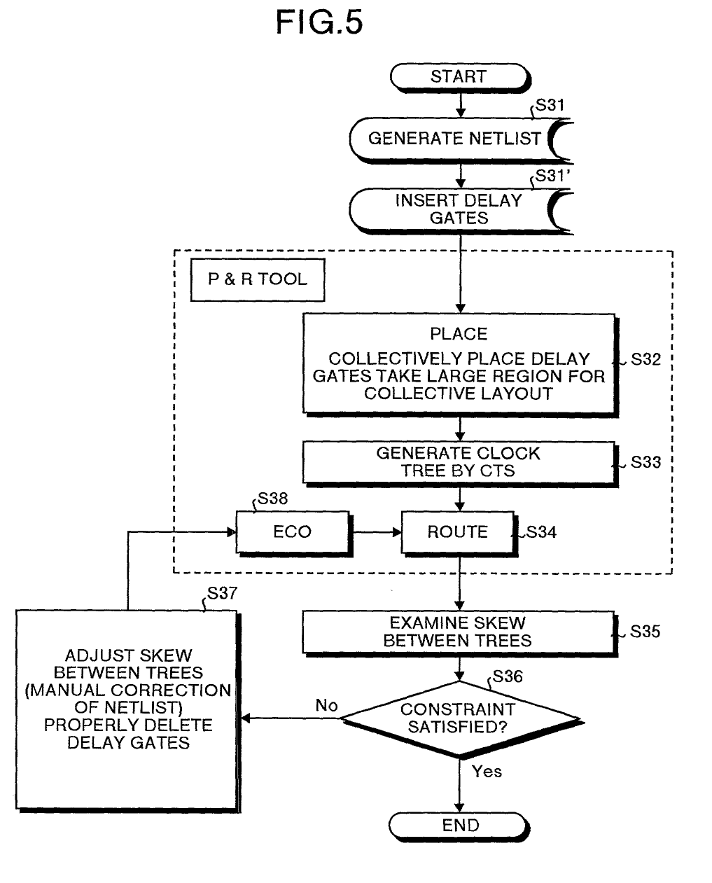

FIG. 5 is a flowchart showing a sequence of processing in a method of designing a semiconductor circuit according to a third embodiment. This method comprises the step S31 of generating a netlist, step S31′ of inserting a delay gate and steps performed by the P & R tool.

The P & R tool performs the following operations. That is, the place step S32 of collectively disposing a plurality of delay gates on a clock line while taking a large region, step S33 of forming clock trees by the CTS function, step S38 of the ECO function, and route step S34.

The method further comprises the step S37 of adjusting a skew between trees, step S35 of examining a skew between the clock trees, and step S36 of determining whether the constraints are satisfied or not.

A netlist is generated in step S31 (in a state where the logic examination has been also finished) and, after that, delay gates are inserted in advance in step S31′.

The P & R tool collectively places delay gates of each of the clock lines in step S32. A clock tree which satisfies the constraint of the timing in the clock tree is generated by the CTS function in step S33 and, after that, route is conducted in step S34.

In order to know whether the constraint of the timing between the clock trees is satisfied or not, in step S35, a delay value of the clock line is calculated by a timing examining tool by using an actual delay value extracted from the place and a timing skew between the clock trees is examined. Since the constraint of the timing in the clock tree is satisfied by the P & R tool, examination is unnecessary.

As a result of examination of a skew between the clock trees in step S35, whether the constraint of the timings between the clock trees is satisfied or not is determined in step S36. If the result of this determination is no, then a skew between the trees is adjusted instep S37. If the result of this determination is yes, then the process in this flowchart is finished.

In step S31′, a plurality of delay gates are preliminarily inserted in the clock line on the netlist. In adjustment of a skew between trees in step S37, the delay gates are properly eliminated from the plurality of delay gates preliminarily inserted. The adjustment of a skew between trees by properly eliminating delay gates from the plurality of delay gates preliminarily inserted is easier than the adjustment by inserting delay gates for the following reason.

Because, when a change in wire length in the case of inserting a delay gate is compared with a change in wire length in the case of eliminating a delay gate, the probability of occurrence of a place change or route change (especially, bypass route which occurs due to a reduction in the route area in association with insertion of a delay gate) in the case where a delay gate is eliminated is lower than that in the case where a delay gate is inserted.

Since a skew between the trees is examined in step S35 before the skew between the trees is adjusted in step S37 (before a delay gate is inserted or eliminated), in the adjustment of the skew between trees in step S37, each of delay gates on the clock line and a route delay related to the delay gate are known. Consequently, a change in the delay value which occurs when a gate is eliminated can be roughly grasped.

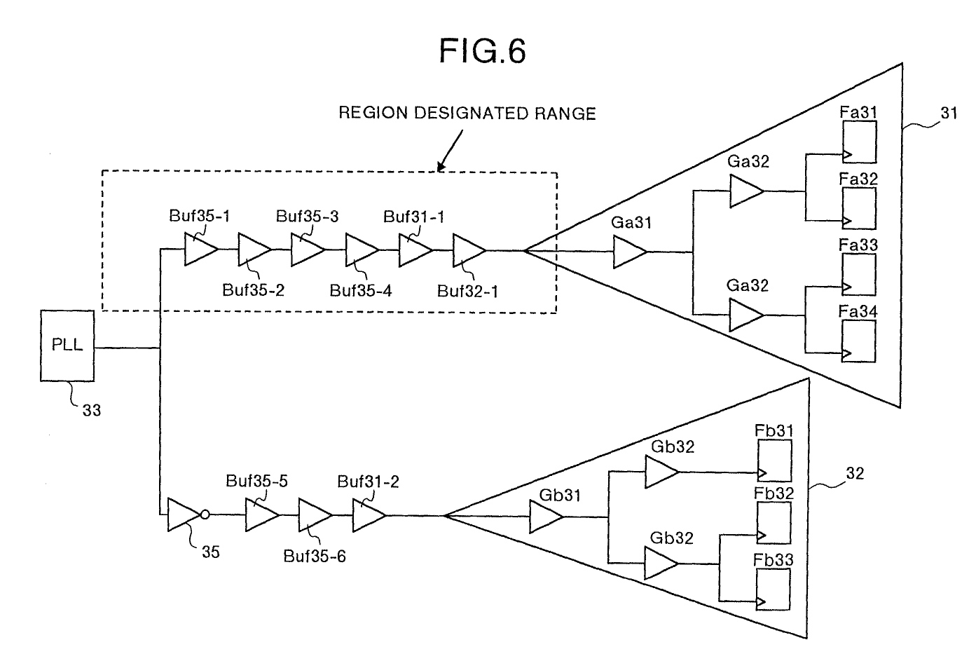

FIG. 6 is a circuit diagram of clock trees according to the third embodiment. This circuit comprises a PLL 33 for outputting a clock A; in inverter circuit 35 for outputting a clock B obtained by inverting the clock A; a clock tree 31 driven by the clock A; and a clock tree 32 driven by the inverted clock B.

The clock tree 31 comprises a plurality of flip-flops Fa31 to Fa34 and a plurality of delay gates Ga31 to Ga33. The clock tree 32 comprises a plurality of flip-flops Fb31 to Fb33 and a plurality of delay gates Gb31 to Gb33.

In step S31′ in the flowchart of FIG. 5, a plurality of delay gates Buf35-1, Buf35-2, Buf35-3, Buf35-4, Buf31-1, and Buf32-1 for delaying the clock tree 31 and a plurality of delay gates Buf35-5, Buf35-6, and Buf31-2 for delaying the clock tree 32 are inserted.

In recent years, although high packing density can be realized by making the structure finer, it becomes necessary to consider the influence of a line adjacent to an arbitrary line. For example, by a change in the clock line in association with adjustment of a skew between trees, the distance between the clock line and another line is shortened and the clock line is influenced.

A larger region of the clock lines is therefore taken at the time of collectively placing clock lines in step S32 so as not to exert an influence of the neighboring lines to the clock line. Lines other than the clock lines are not disposed in the region (gates except for the delay gates are not also disposed) Thus, the influence of the other lines on the clock lines can be eliminated and the adjustment of a skew between the trees can be facilitated.

According to the third embodiment, as compared with the skew adjusting method of the second embodiment, the time required by the adjustment of a skew between trees can be further shortened.

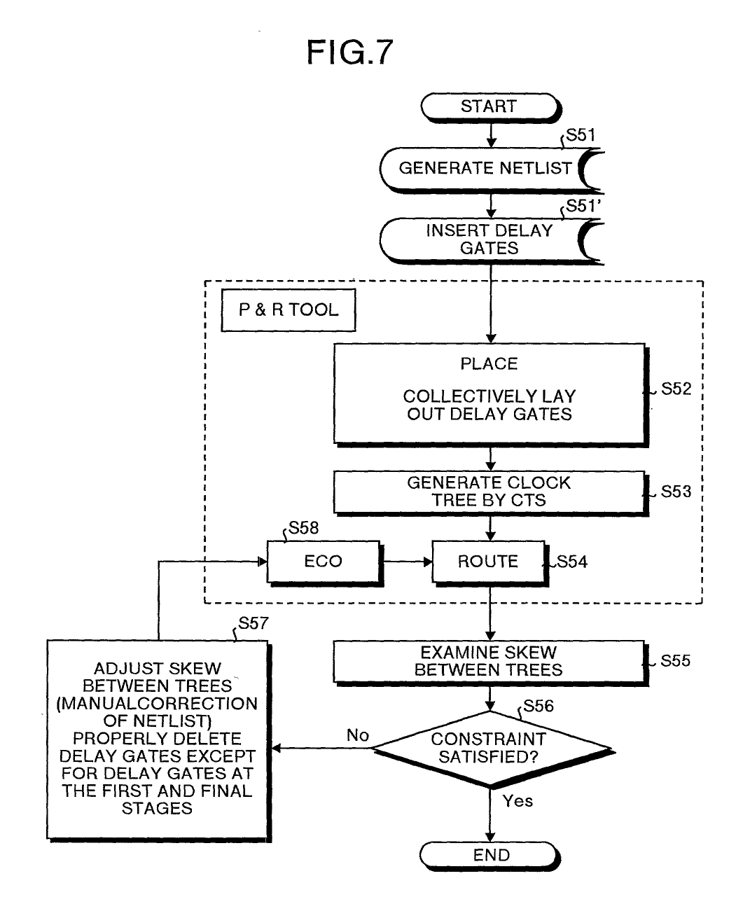

FIG. 7 is a flowchart showing a sequence of processing in a method of designing a semiconductor circuit according to a fourth embodiment. This method comprises the step S51 of generating a netlist, step S51′ of inserting delay gates and steps performed by the P & R tool.

The P & R tool performs the following operations. That is, place step S52, step S53 of generating a clock tree by the CTS function, step S58 of an operation by the ECO function, and route step S54.

The method further comprises the step S57 of adjusting a skew between trees by eliminating a delay gate from the plurality of delay gates preliminarily inserted while not regarding delay gates at the first and last stages as targets to be eliminated, step S55 of examining a skew between the clock trees, and step S56 of determining whether the constraint is satisfied or not.

A netlist is generated in step S51 (in a state where the logic examination has been also finished) and, after that, delay gates are inserted in advance in step S51′.

The P & R tool collectively places delay gates of each of the clock lines in step S52. A clock tree which satisfies the constraint of the timing in the clock tree is generated by the CTS function in step S53 and, after that, route is conducted in step S54.

In order to know whether the constraint of the timing between the clock trees is satisfied or not, in step S55, a delay value of the clock line is calculated by a timing examining tool by using an actual delay value extracted from the place and a timing skew between the clock trees is examined. Since the constraint of the timing in the clock tree is satisfied by the P & R tool, examination is unnecessary.

As a result of examining a skew between the clock trees in step S55, whether the constraint of the timings between the clock trees is satisfied or not is determined in step S56. If the result of this determination is no, then the skew between the trees is adjusted in step S57. If the result this determination is yes, then the process in this flowchart is finished.

In step S51′, a plurality of delay gates are preliminarily inserted in a clock line on a netlist. The delay gates are properly eliminated from the plurality of delay gates preliminarily inserted to adjust the skew between the trees in step S57. The adjustment of a skew between trees by properly eliminating delay gates from the plurality of delay gates preliminarily inserted is easier than the adjustment by inserting a delay gate for the following reason.

Among lines related to the delay gates, the longest lines are a line extending from the output pin of a clock generating source (such as a PLL) to the delay gate at the first stage in the plurality of delay gates and a line extending from the output pin of the delay gate at the final stage to the clock tree.

When a skew between trees is adjusted in a state where the positions of the delay gates at the first and final stages among the plurality of delay gates preliminarily inserted are fixed and, the delay gates at the first and final stages are fixed since they are excluded from the targets to be eliminated, a change in route can be suppressed.

According to the fourth embodiment, a change in route at the time of adjusting a skew between trees can be suppressed. As compared with the skew adjusting method in the second embodiment, the time required for adjusting a skew between trees can be further shortened.

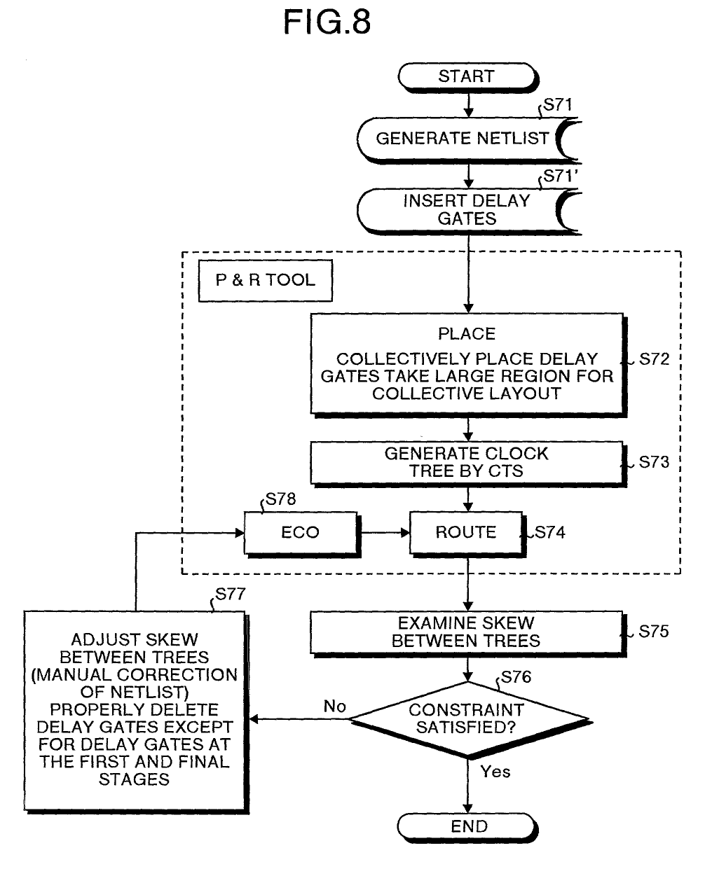

FIG. 8 is a flowchart showing a sequence of processing in a method of designing a semiconductor circuit according to a fifth embodiment. This method comprises the step S71 of generating a netlist, step S71′ of inserting delay gates and steps performed by the P & R tool.

The P & R tool performs the following operations. That is, place step S72, step S73 of generating clock trees by the CTS function, step S78 of an operation by the ECO function, and route step S74.

The method further comprises the step S77 of adjusting a skew between trees, step S75 of examining a skew between the clock trees, and step S76 of determining whether the constraint is satisfied or not.

A netlist is generated in step S71 (in a state where the logic examination has been also finished) and, after that, delay gates are inserted in advance in step S71′.

The P & R tool collectively places delay gates of each of the clock lines in step S72. A clock tree which satisfies the constraint of the timing in the clock tree is generated by the CTS function in step S73 and, after that, route is conducted in step S74.

In order to know whether the constraint of the timing between the clock trees is satisfied or not, in step S75, a delay value of the clock line is calculated by a timing examining tool by using an actual delay value extracted from the place and a timing skew between the clock trees is examined. Since the constraint of the timing in the clock tree is satisfied by the P & R tool, examination is unnecessary.

As a result of examining a skew between the clock trees in step S75, whether the constraint of the timings between the clock trees is satisfied or not is determined in step S76. If the result of this determination is no, then the skew between the trees is adjusted in step S77. If the result of this determination is no, then the process in this flowchart is finished.

In step S71′, a plurality of delay gates are preliminarily inserted in a clock line on the netlist. The delay gates are properly eliminated from the plurality of delay gates preliminarily inserted to adjust the skew between the trees in step S77. The adjustment of a skew between trees by properly eliminating delay gates from the plurality of delay gates preliminarily inserted is easier than the adjustment by inserting a delay gate for the following reason.

When a change in wire length in the case of inserting a delay gate is compared with a change in wire length in the case of eliminating a delay gate, the probability of occurrence of a place change or route change (especially, bypass route which occurs due to a reduction in the route area in association with insertion of a delay gate) in the case where a delay gate is eliminated is lower than that in the case where a delay gate is inserted.

Since a skew between the trees is examined in step S75 before the skew between the trees is adjusted in step S77 (before a delay gate is inserted or eliminated), in the adjustment of the skew between trees in step S77, each of delay gates on the clock line and a route delay related to the delay gate are known. Consequently, a change in the delay value which occurs when a gate is eliminated can be roughly grasped.

A large region is taken at the time of collectively placing clock lines in step S72 so as not to exert an influence of adjacent lines onto the clock lines. In the region, lines except for the clock lines are not disposed (gates other than the delay gates are not also disposed).

By the arrangement, the influence of the other lines to the clock lines can be prevented and the adjustment of a skew between the trees is facilitated.

Further, in the case of adjusting a skew between trees, the delay gates at the first and final stages are fixed and are excluded from the target delay gates to be eliminated.

According to the fifth embodiment, the time required to adjust a skew between the trees can be further shortened.

The method of designing a semiconductor circuit having clock trees according to the invention, comprises the steps of generating a netlist; preliminarily inserting a plurality of delay gates onto the netlist; and deleting the proper number of the delay gates while performing adjustment so as to satisfy the constraint of a timing between the clock trees. Consequently, the time required to adjust a skew between the trees can be shortened.

The invention can be realized by an existing apparatus without requiring a dedicated place library for clock lines or a dedicated CAD tool.

The method of designing a semiconductor circuit according to one aspect of this invention comprises the step of generating a netlist; inserting a plurality of delay gates onto the netlist; place; generating the clock trees which satisfy a constraint of a timing in the clock tree; route; manually adjusting a skew between the clock trees by deleting some of the inserted delay gates based on the constraint of the timing between the clock trees; examining the skew between the clock trees; determining whether the constraint of the timing is satisfied or not; and making a minimum change in the place and route in association with the insertion of the delay gates. Consequently, the time required to adjust a skew between trees can be further shortened.

Further, in the step of place, the plurality of delay gates on the clock line may be collectively placed. In this case, the time required to adjust a skew between trees can be further shortened.

Further, in the step of place, it is also possible to collectively place a plurality of delay gates on the clock line and assure a large region. The time required to adjust the skew between trees can be further shortened.

Further, in the step of adjusting a skew between trees, the delay gates at the first and last stages among the plurality of delay gates preliminarily inserted may not be regarded as targets to be deleted. In this case, the time required to adjust a skew between trees can be further shortened.

The semiconductor circuit of the invention is designed by using any one of the above methods of designing a semiconductor circuit, the time required for the circuit to adjust a skew between trees can be shortened.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of designing a semiconductor circuit having clock trees, the method comprising the steps of:
generating a netlist;
inserting a plurality of delay gates onto said netlist;
place;
generating said clock trees which satisfy a constraint of a timing in said clock tree;
route;
manually adjusting a skew between said clock trees by deleting some of said inserted delay gates based on the constraint of the timing between said clock trees;
examining the skew between said clock trees;
determining whether the constraint of the timing is satisfied or not; and
making a minimum change in the place and route in association with the insertion of said delay gates.

2. The method of designing a semiconductor circuit according to claim 1, wherein in the step of place, a plurality of delay gates on said clock line are collectively placed.

3. The method of designing a semiconductor circuit according to claim 1, wherein in the step of place, a plurality of delay gates on said clock line are collectively placed and a large region is assured.

4. The method of designing a semiconductor circuit according to claim 2, wherein in the step of adjusting a skew between trees, said delay gates at the first and last stages among said inserted delay gates are not regarded as targets to be deleted.

5. The method of designing a semiconductor circuit according to claim 3, wherein in the step of adjusting a skew between trees, said delay gates at the first and last stages among said inserted delay gates are not regarded as targets to be deleted.

6. A semiconductor circuit having clock trees, said semiconductor circuit being designed using a designing method comprising the steps of:
generating a netlist;
inserting a plurality of delay gates onto said netlist;
place;
generating said clock trees which satisfy a constraint of a timing in said clock tree;
route;
manually adjusting a skew between said clock trees by deleting some of said inserted delay gates based on the constraint of the timing between said clock trees;
examining the skew between said clock trees;
determining whether the constraint of the timing is satisfied or not; and
making a minimum change in the place and route in association with the insertion of said delay gates.
